(19) United States
(12) Patent Application Publication
(10) Pub. No.: US 2026/0369080 A1
(43) Pub. Date: Nov. 19, 2026

(54) VEHICULAR DRIVING ASSIST SYSTEM WITH VEHICLE POSITION ESTIMATION

(71) Applicant: Magna Electronics Inc., Auburn Hills, MI (US)

(72) Inventors: Arpit Awathe, Rochester Hills, MI (US); Abizer Patanwala, Rochester Hills, MI (US)

(21) Appl. No.: 19/671,758

(22) Filed: May 8, 2026

Related U.S. Application Data
(60) Provisional application No. 63/805,401, filed on May 14, 2025.

(51) Int. Cl. G06V 20/56; B60W 30/12; B60W 30/18; B60W 60/00; G01S 13/86; G01S 13/931; G06T 7/73

(52) U.S. Cl. CPC G06V 20/588; B60W 30/12; B60W 30/18163; G01S 13/867; G01S 13/931; G06T 7/73; B60W 60/001; B60W 2420/403; B60W 2420/408; B60W 2520/06; B60W 2520/10; B60W 2520/105; B60W 2520/14; B60W 2540/223; B60W 2552/20; B60W 2552/53; G06T 2207/30256

(57) ABSTRACT

A vehicular driving assist system, responsive to processing of sensor data captured by a sensor at a first time interval, determines a first position of a road boundary of a road. The system determines, based on the determined first position, a first pose of the vehicle relative to the road boundary at the first time interval. The system, responsive to processing of sensor data captured by the sensor at a second time interval, determines a second position of the road boundary at the second time interval. The system determines, based on the determined second position, a second pose of the vehicle relative to the road boundary at the second time interval. The system, based on the determined first pose and the determined second pose, determines (i) a curvature of a path of travel of the vehicle and (ii) a yaw rate of the vehicle.

### CROSS REFERENCE TO RELATED APPLICATION

The present application claims the filing benefits of U.S. provisional application Ser. No. 63/805,401, filed May 14, 2025, which is hereby incorporated herein by reference in its entirety.

### TECHNICAL FIELD

The present disclosure relates generally to a vehicle vision system for a vehicle and, more particularly, to a vehicle vision system that utilizes one or more cameras at a vehicle.

### BACKGROUND

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY

A vehicular driving assist system includes a sensor disposed at a vehicle equipped with the vehicular driving assist system and sensing exterior of the vehicle. The sensor is operable to capture sensor data. The system includes an electronic control unit (ECU) with electronic circuitry and associated software. The electronic circuitry of the ECU includes a data processor for processing sensor data captured by the sensor. The ECU, responsive to processing by the data processor of sensor data captured by the sensor at a first time interval, determines a first position of a road boundary of a road along which the vehicle is traveling. The vehicular driving assist system determines, based at least in part on the determined first position of the road boundary, a first pose of the vehicle relative to the lane boundary at the first time interval. The system, responsive to processing by the data processor of sensor data captured by the sensor at a second time interval, determines a second position of the road boundary at the second time interval. The vehicular driving assist system determines, based at least in part on the determined second position of the road boundary at the second time interval, a second pose of the vehicle relative to the lane boundary at the second time interval. The vehicular driving assist system, based at least in part on the determined first pose and the determined second pose, determines (i) a curvature of a path of travel of the vehicle and (ii) a yaw rate of the vehicle.

These and other objects, advantages, purposes and features of the present disclosure will become apparent upon review of the following specification in conjunction with the drawings.

### BRIEF DESCRIPTION OF THE DRAWINGS

FIG. 1 is a plan view of a vehicle with a driving assist system that incorporates at least one camera;

FIG. 2 is a block diagram of a vehicle state estimation module for a vehicular driving assist system;

FIG. 3 is a block diagram of a vehicle curvature calculation module for a vehicular driving assist system;

FIG. 4 is a plan view of a vehicle traveling along a road;

FIG. 5 is a plan view of possible headings of the vehicle of FIG. 4;

FIG. 6 is a plan view of the vehicle of FIG. 4 traveling along a curvature of the road, showing change in heading angle of the vehicle along the road curvature;

FIG. 7 is a plan view of the vehicle of FIG. 4 traveling along a curvature of the road, showing a lateral offset of the vehicle from a boundary of the road; and

FIG. 8 is a diagram of calculations performed by a vehicular driving assist system.

### DETAILED DESCRIPTION

A vehicle sensing system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. In some examples, the objects comprise pedestrians, other vehicles, bicycles, traffic signs, road debris, and roadside barriers. The vehicle sensing system may utilize the captured image data to generate warning signals or control signals for the vehicle. The vision system includes an image processor or image processing system operable to receive image data from one or more cameras and provide an output to a display device for displaying images representative of the captured image data. Optionally, the vision system may provide display, such as a rearview display or a top down or bird's eye or surround view display or the like. In some exemplary implementations, the display device comprises a touchscreen monitor positioned within a dashboard of the vehicle, a rearview mirror display, or a head-up display projected onto a windshield of the vehicle.

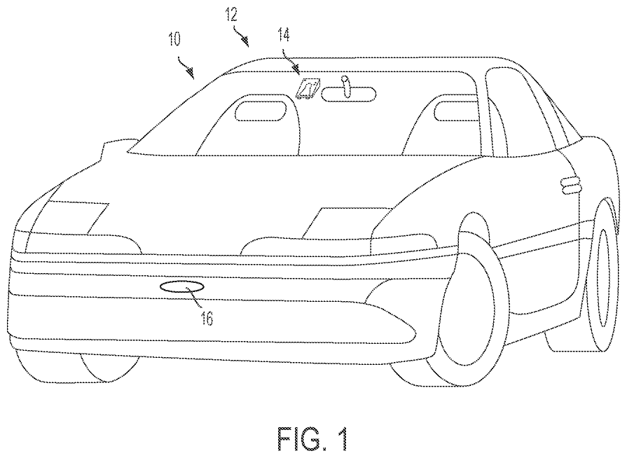

Referring now to the drawings and the illustrative exemplary implementations depicted therein, a vehicle 10 includes vehicular driving assist system 12 including at least one exterior-viewing imaging sensor or camera, such as a forward-viewing imaging sensor or camera 14. The forward-viewing camera 14 may be disposed at an in-cabin side of the windshield of the vehicle 10 and viewing forward through the windshield so as to capture image data representative of the scene occurring forward of the vehicle 10 (FIG. 1). Optionally, the vehicular driving assist system 12 may include multiple exterior-viewing imaging sensors or cameras, such as a forward-viewing camera at the front of the vehicle 10, and sideward/rearward-viewing cameras at respective sides of the vehicle 10, and a rearward-viewing camera at the rear of the vehicle 10 (e.g., a rear backup camera of the vehicle 10) configured to capture images exterior of the vehicle 10. The camera or cameras each include a lens for focusing images at or onto an imaging array or imaging plane or imager of the camera.

The forward-viewing camera 14 disposed at the windshield of the vehicle 10 views through the windshield and forward of the vehicle 10, such as for a machine vision system (such as for traffic sign recognition, headlamp control, pedestrian detection, collision avoidance, lane marker detection and/or the like). The vehicular driving assist system 12 includes a control or electronic control unit (ECU) having electronic circuitry and associated software, with the electronic circuitry including a data processor or image processor operable to process image data captured by the camera or cameras, whereby the ECU may detect or determine presence of objects or the like and/or the vehicular driving assist system 12 may provide displayed images at a display device for viewing by the driver of the vehicle 10. The ECU may process sensor data captured by the sensor at a first time interval to determine a first position of a road boundary of a road along which the vehicle 10 is traveling. The road boundary may comprise a lane marker, an edge of the road, and/or a border of the road. The data transfer or signal communication from the forward-viewing camera 14 to the ECU may comprise a data or communication link, such as a vehicle network bus or the like of the equipped vehicle 10. The vehicle network bus may comprise a Controller Area Network (CAN) bus, a Local Interconnect Network (LIN) bus, or an Automotive Ethernet connection.

The vehicular driving assist system 12 may include at least one radar sensor unit, such as a forward-sensing radar sensor unit 16 (and the vehicular driving assist system 12 may optionally include multiple exterior-sensing sensors, such as cameras, radar, or other sensors, such as a rearward-sensing sensor at the rear of the vehicle 10, and a sideward/rearward-sensing sensor at respective sides of the vehicle 10) configured to sense regions exterior of the vehicle 10. Optionally, the vehicular driving assist system 12 may include an interior-sensing radar sensor sensing within an interior cabin of the vehicle 10, such as for occupant detection at one or more seats of the vehicle 10. The ECU includes a data processor operable to process data captured by the radar sensor 16. The radar sensor 16 may include a plurality of transmitters configured to transmit radio signals via a plurality of antennas. In some exemplary implementations, the transmitted radio signals comprise millimeter-wave radio frequencies. The radar sensor 16 may include a plurality of receivers configured to receive radio signals via the plurality of antennas. The received radio signals are transmitted radio signals reflected from an object. The ECU or processor is operable to process the received radio signals to sense or detect the object reflecting the received radio signals. The vehicular driving assist system 12 may control at least one function or feature of the vehicle 10 (such as to provide autonomous driving control of the vehicle 10) responsive to processing at the ECU of the data captured by the radar sensor 16 and/or the forward viewing camera 14. For example, the vehicular driving assist system 12 may actuate a braking system of the vehicle 10 or output a steering command to a steering system of the vehicle 10. The data transfer or signal communication from the radar sensor 16 to the ECU may comprise a data or communication link, such as a vehicle network bus or the like of the equipped vehicle 10.

A vehicle 10 may be equipped with image sensors (e.g., cameras), radars, ultrasonic sensors, Light Detection and Ranging (LIDAR) sensors, and the like, to capture data regarding objects proximate to the vehicle 10 (e.g., vehicles, pedestrians, buildings, barricades, and other structural elements) as well as data regarding the environment surrounding the vehicle 10 (e.g., lane markers, road signs, intersections, road edges, and additional environmental indicators). Vehicular vision systems, the vehicular driving assist system 12, an Advanced Driving Assist System (ADAS), vehicle control systems, semi-autonomous driving features, and/or fully autonomous driving modes of the vehicle 10 may use the captured data to determine distance between the vehicle 10 and a detected object, velocity of a detected object, and/or to determine a path for the vehicle 10. Determining vehicle state information (e.g., vehicle pose, curvature, yaw rate, and additional kinematic parameters) of the equipped vehicle 10 enables the vehicular driving assist system 12 to accurately control the vehicle 10 and/or provide data and/or alerts to a driver of the vehicle 10.

The vehicular driving assist system 12 may use data captured by cameras, radars, and/or other sensors of the vehicle 10 regarding road boundaries, such as lane markers, road edges, and/or road borders, at two or more time intervals to determine changes in a pose of the vehicle 10 between the two or more time intervals. For instance, the vehicular driving assist system 12 may determine a first pose of the vehicle 10 relative to the road boundary at a first time interval and determine a second pose of the vehicle 10 relative to the road boundary at a second time interval. Based at least in part on the determined changes in vehicle pose, the vehicular driving assist system 12 may derive and/or calculate curvature of the road along which the vehicle 10 is traveling (i.e., a predicted path of the vehicle 10) and yaw rate of the vehicle 10. Optionally, the vehicular driving assist system 12 may control steering and/or acceleration of the vehicle 10 based on the determined pose data, road or trajectory curvature, and/or yaw rate of the vehicle 10. Additionally or alternatively, the vehicular driving assist system 12 may output the determined pose data, road or trajectory curvature, and/or yaw rate to another system of the vehicle 10, such as a lane-centering system, a lane-change assist system, a lane-keep assist system, and/or a hands-free driving system.

The vehicular driving assist system 12 and/or Advanced Driving Assistance System (ADAS) may gather data about the surrounding environment through various sensors. Various advanced assistance features may use the gathered data. The vehicular driving assist system 12 may utilize the gathered data for vehicle pose estimation, where a vehicle pose includes collective position information and orientation, including a vehicle longitudinal position Tx, a vehicle lateral position Ty, and a vehicle heading angle θ. The vehicular driving assist system 12 may use the estimated pose to determine a curvature of a path of travel of the vehicle 10 and a yaw rate of the vehicle 10. A vehicle state estimation algorithm of a vehicle 10 equipped with a camera 14, a radar sensor 16, or both may enable the vehicular driving assist system 12 and/or the ADAS to estimate vehicle pose and calculate road or trajectory curvature and yaw rate for the vehicle 10. The sensors may collect data regarding lanes and surrounding stationary road features, such as road borders or road edges.

The vehicle state estimation algorithm may help reduce or eliminate a requirement for additional sensors to measure and obtain vehicle states, such as the vehicle pose, curvature, and yaw rate. In some exemplary implementations, calculating the road curvature directly from the estimated pose enables a reduction in computational load on the data processor. Optionally, the vehicular driving assist system 12 may use additional sensors and may utilize the vehicle pose estimation, road or trajectory curvature, and vehicle yaw rate as an additional input to perform improved data fusion, achieving more accurate vehicle state estimation with respect to the vehicle pose, road or trajectory curvature, and vehicle yaw rate. The data fusion may include applying an extended Kalman filter or a particle filter to combine the vehicle pose estimation with separate inertial measurement unit data.

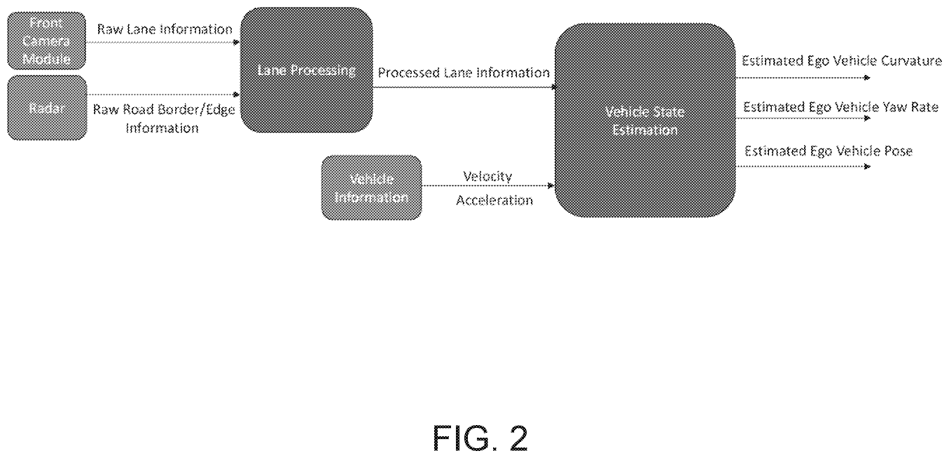

FIG. 2 illustrates an exemplary implementation of a vehicle state estimation module. A front camera module (FCM) captures image data including raw lane data and object data forward of the vehicle 10, such as lane coefficients, quality values, relative position of objects, velocity, acceleration, and object type. The radar sensor 16 captures raw object data, such as relative position of objects, velocity, acceleration, and object type, along with stationary road objects (e.g., road borders and road edges). A lane processing module outputs smooth lane coefficients by filtering raw lane data and raw road edge data captured by the FCM and/or the radar sensor 16. In some examples, filtering the raw lane data and the raw road edge data comprises applying a Kalman filter or a low-pass filter to reduce signal noise.

The lane processing module determines lane markers and/or road edges for vehicle state estimation responsive to evaluated conditions being met. The evaluated conditions may include a first condition wherein the lane markers and/or road edges are not narrowing or widening, a second condition wherein the lane markers and/or road edges may be determined with a confidence value meeting or exceeding a threshold confidence value, and a third condition wherein lane marker coefficients and/or road edge coefficients do not rise above a threshold coefficient value. The evaluated conditions maximize valid selection of lane marks and road edges. A vehicle information module outputs vehicle state data for the equipped vehicle 10, such as velocity, longitudinal acceleration, lateral acceleration, and vehicle dynamics data. In some implementations, the vehicle dynamics data comprises a steering angle and a wheel speed.

A vehicle state estimation module (i.e., a vehicle state estimation block) includes a software module utilizing lane data (e.g., lane marker data), road border data, and/or road edge data, velocity of the vehicle 10, and acceleration of the vehicle 10 to estimate the pose of the vehicle 10 and calculate road or trajectory curvature and yaw rate of the vehicle 10. The road or trajectory curvature comprises a geometric curve corresponding to a path of travel of the vehicle 10.

The FCM provides data about lane markers and road edges relative to the vehicle 10 at each time interval of a plurality of time intervals, and the radar sensor 16 provides data about road borders. The data of the FCM and the radar sensor 16 includes location data and geometric data representative of a view range of the vehicle 10 as detected by the sensors (i.e., the FCM and the radar sensor 16). In some examples, the geometric data comprises a curve radius of the road and a polynomial equation modeling a contour of the road. Responsive to forward movement of the vehicle 10, data regarding the lane markers, road borders, and/or road edges may be used to determine a pose of the vehicle 10, and the determined pose of the vehicle 10 may be used to determine estimated locations of the lane markers, road borders, and/or road edges, as well as geometric details, and therefore determine an estimated projected pose of the vehicle 10. The vehicle state estimation transforms previously determined details based on movement of the vehicle 10 along the road. Transforming the previously determined details may comprise applying a coordinate transformation matrix to update the location data and the geometric data relative to a new position of the vehicle 10.

If the vehicle 10 moves straight without changing a path, a heading, and/or a trajectory of the vehicle 10, the projected pose and/or state may be determined based on velocity and longitudinal acceleration of the vehicle 10. For instance, the vehicular driving assist system 12 may integrate the velocity and the longitudinal acceleration over a designated time interval to calculate a linear displacement of the vehicle 10. If the vehicle 10 changes heading angle, or deviates from a previous path of the vehicle 10, the vehicular driving assist system 12 may perform a rotational determination and/or a rotational transformation. Performing the rotational transformation may include multiplying coordinate vectors associated with the lane markers, the road borders, and the road edges by a rotation matrix derived from the changed heading angle. Whether the vehicle 10 is moving straight or is turning or moving along a curved path, having data regarding the previous lane markers, road borders, and/or road edges enables the vehicle state estimation module to determine new locations and geometric details of the vehicle 10 based on the transformation.

Capturing and determining instances of data regarding lane markers, road borders, and/or road edges during operation of the vehicle 10 may be used to determine changes in the pose of the vehicle 10 between two instances of the data. Determining previous and current lane markers, road borders, and/or road edges at a given instance may be used to determine changes in pose of the vehicle 10 between two instances of data. A specific change in the pose of the vehicle 10 results in particular positions of lane markers, road edges, or road borders in a separate instance. The vehicle state estimation algorithm may determine changes in the pose of the vehicle 10 based on the positions of lane markers, road edges, or road borders at two consecutive time intervals using data captured by the forward-viewing camera 14 (e.g., the FCM) and/or the radar sensor 16 of the vehicle 10. For example, the electronic control unit (ECU) may determine a first position of a road boundary at a first time interval and determine a second position of the road boundary at a second time interval to calculate a relative translation and a relative rotation of the vehicle 10. The determined change in the pose of the vehicle 10 across two or more time intervals may be used to determine the curvature of the path of travel and the yaw rate of the vehicle 10. Determining the yaw rate of the vehicle 10 may comprise calculating a rate of change of the heading angle over the two or more time intervals. Determining the curvature of the path of travel may comprise evaluating a lateral displacement of the vehicle 10 relative to a longitudinal distance traveled by the vehicle 10.

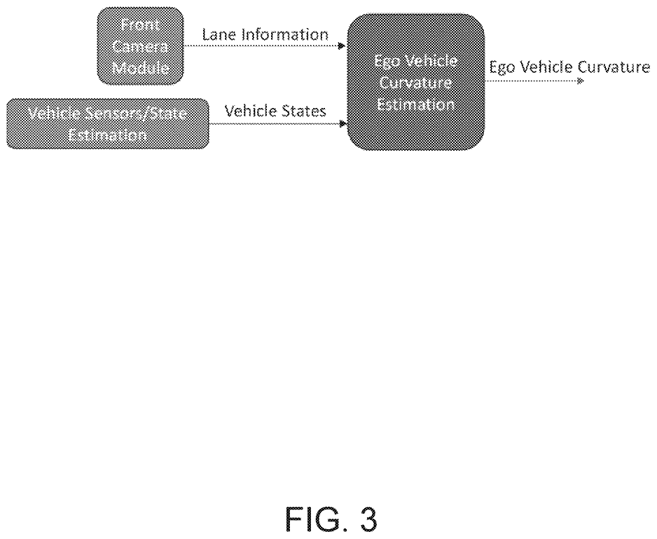

As shown in FIG. 3, in some examples, the vehicular driving assist system 12 may determine a curvature of the road ahead of the vehicle 10 and thus curvature of the path of travel or trajectory of the vehicle 10 based on lane information and vehicle state estimations. The lane information may be determined by image data captured by the front camera module (FCM), including positions of lane markers and/or road edges with respect to the vehicle 10. The vehicle state estimations may include pose data. In some exemplary implementations, the pose data comprises a first pose of the vehicle 10 relative to a road boundary at a first time interval and a second pose of the vehicle 10 relative to the road boundary at a second time interval. Additionally or alternatively, the vehicle state information may include vehicle sensor data for one or more vehicle sensors, such as one or more cameras of the vehicle 10 (e.g., a camera mounted to a front bumper, a rear bumper, and/or one or more side mirrors of the vehicle 10), Light Detection and Ranging (LIDAR) sensors of the vehicle 10, and/or ultrasonic sensors of the vehicle 10. The vehicle sensor data may include lane markers, road edges, road borders, and/or objects proximate to the vehicle 10. Optionally, the curvature of the path of travel or trajectory of the vehicle 10 may be determined based on velocity and/or acceleration of the vehicle 10. For instance, the vehicular driving assist system 12 may integrate signals from wheel speed sensors and inertial measurement units to supplement the image data in determining the curvature of the path of travel.

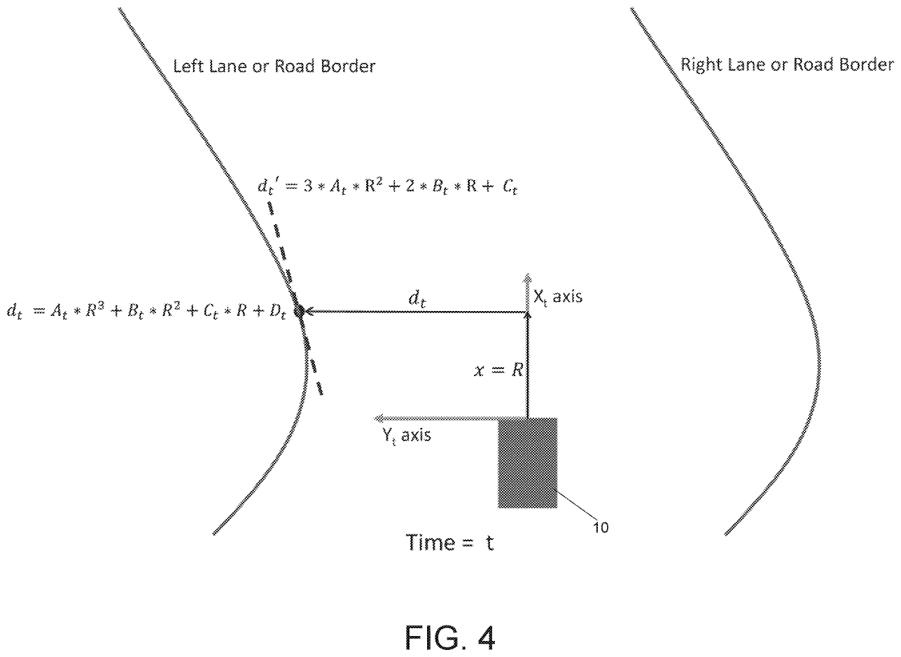

Referring now to FIG. 4, the lane information, including lane marker and road edge data, captured by the FCM (such as the forward-viewing camera 14) and the road border data captured by the radar sensor 16 may be expressed as a cubic polynomial equation in the reference frame of the equipped or ego vehicle 10. At a first time interval t, the coefficients of the polynomial equation include Aₜ, Bₜ, Cₜ, Dₜ. In some examples, the polynomial coefficients parameterize a curve describing the road boundary, where coefficient At represents a curvature rate of change, coefficient Bₜ represents a curvature of the road boundary, coefficient Cₜ represents a heading angle of the road boundary relative to the vehicle 10, and coefficient Dₜ represents a lateral displacement. A lateral offset Y refers to a perpendicular distance of a lane from the equipped vehicle 10. The lateral offset Y at a longitudinal distance x from the coordinate frame of the equipped vehicle 10 is represented by Equation (1), below.

Y=Aₜ*x³+Bₜ+*x²+Cₜ*x+Dₜ (1)

A lane curvature of a lane along which the vehicle is traveling refers to a curvature of the lane with respect to the vehicle. A derivative of Equation (1), Y′, provides the lane heading at distance x from the vehicle and is represented by Equation (2), below.

Y′=3*Aₜ*x²+2*Bₜ*x+Cₜ (2)

The derivative Y′ represents a tangent slope of the cubic polynomial equation at the specified longitudinal distance x, thereby mathematically reflecting an instantaneous angle of the road boundary. For a given longitudinal velocity v of the vehicle 10, and assuming that the vehicle 10 is accelerating at a constant longitudinal acceleration a (which may be zero), the vehicle 10 will have traveled a longitudinal distance R by a second time interval separated from the first time interval t by a time step increment dt. The traveled longitudinal distance R is represented by Equation (3), below.

$$R = v * d t + \frac{1}{2} * a * d {t}^{2} \qquad ( 3 )$$

By utilizing the longitudinal velocity v and the constant longitudinal acceleration a, the vehicular driving assist system 12 mathematically projects a spatial position of the vehicle 10 at the second time interval. The lateral offset Y at the traveled longitudinal distance R from the vehicle 10 at the first time interval t is represented by a parameter dt. The lane heading evaluated at the traveled longitudinal distance R is represented by dₜ′. Calculating the parameter dₜ enables the vehicular driving assist system 12 to quantify an expected lateral displacement of the road boundary relative to the coordinate frame of the vehicle 10 at the traveled longitudinal distance R.

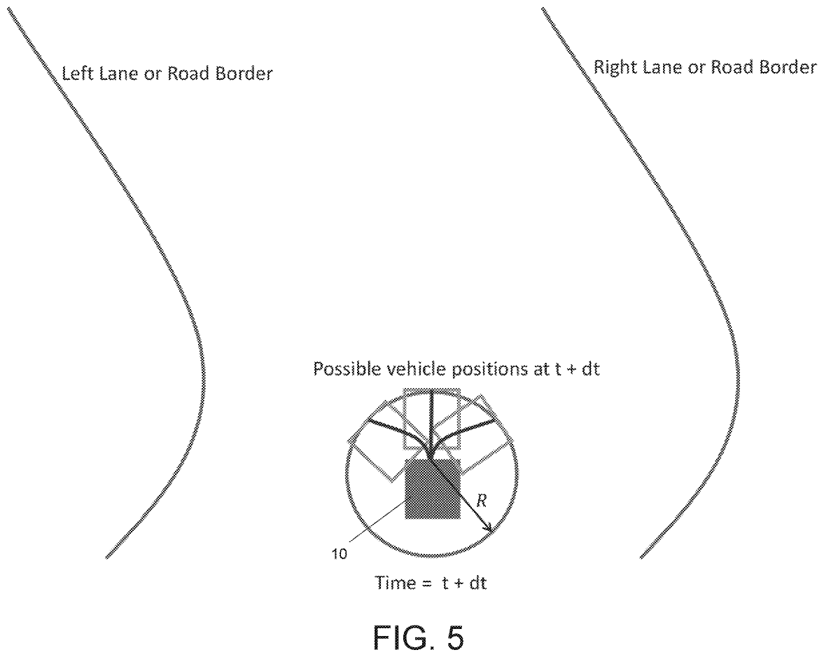

As illustrated in FIG. 5, because projected steering inputs of the driver may be unmeasured (e.g., whether the driver will continue to drive the vehicle 10 straight or turn from the current heading of the vehicle 10), possible projected positions of the vehicle 10 are determined. Even if the vehicle 10 changes heading, the vehicle 10 travels to and reaches a point on a hypothetical circle having a radius R and a center (i.e., origin) at the current location of the vehicle 10 at the first time interval t. The hypothetical circle mathematically bounds an envelope of possible geographic locations the vehicle 10 may reach given the calculated traveled longitudinal distance R.

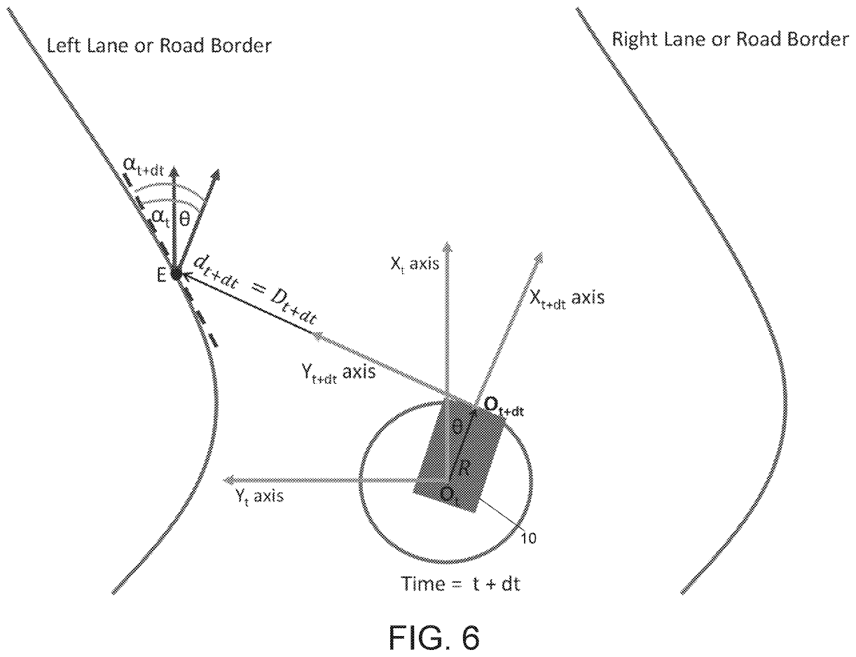

As shown in FIG. 6, in examples where the vehicle moves forward in an angular motion that deviates from the longitudinal axis of the vehicle at time t (i.e., the Xₜ axis) by a heading angle of θ, the vehicle reaches a point O_{t+dt} at time t+dt. The heading angle θ is an angle representing the heading of the vehicle relative to the curvature of the road or ahead of the vehicle. Accordingly, the vehicle axes change from (Xₜ, Yₜ) at time t to (X_{t+dt}, Y_{t+dt}) at time t+dt. The lateral offset Y_{t+dt} from the vehicle origin O_{t+dt} with respect to the vehicle axis X_{t+dt} is denoted by d_{t+dt} at time t+dₜ. A tangent angle at from the vehicle axis Xₜ at origin Oₜ₊₁ makes angle ‘αₜ’ from axis ‘Xₜ’ and angle ‘α_{t+dt}’ from axis ‘X_{t+dt}’. The heading angle θ is represented by Equation (4), below.

αₜ−α_{t+dt}=θ (4)

The transformation of the vehicle axes allows the vehicular driving assist system 12 to decouple rotational motion of the vehicle 10 from translational motion of the vehicle 10. The heading angle θ may be determined recursively for better estimation. For example, the vehicular driving assist system 12 may initially assign an initial heading angle estimate θᵢ for heading angle θ, which may be used to improve the estimation and determine the actual value θ. The recursive estimation may comprise applying an iterative root-finding algorithm or a least-squares optimization to minimize mathematical error between the initial heading angle estimate θᵢ and sensor data updates. Responsive to determining the heading angle θ, the vehicular driving assist system 12 may estimate other vehicle states. The other vehicle states may include a calculated yaw rate and a lateral translation parameter.

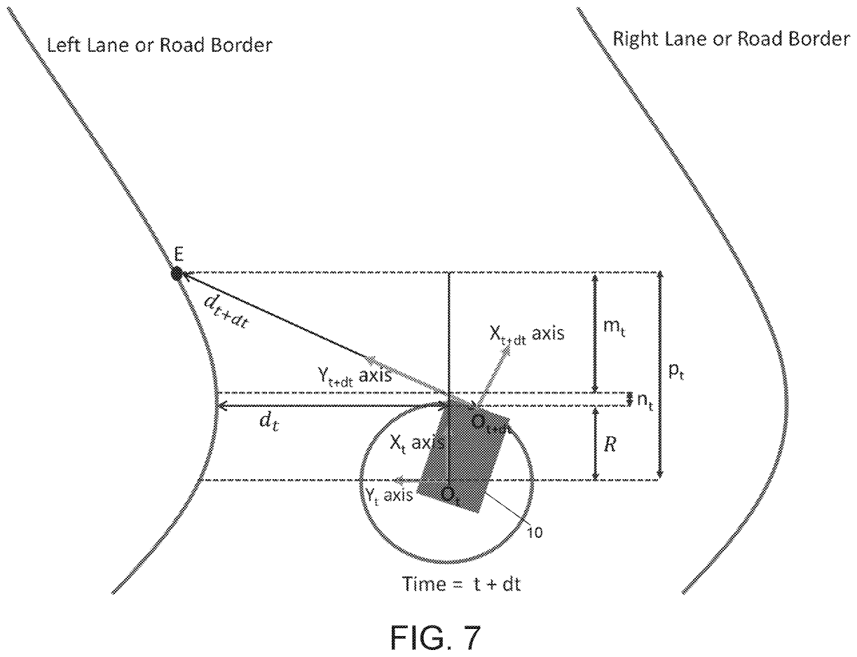

FIG. 7 illustrates distance pₜ from the origin Oₜ a point E along the left road border. Distance pₜ is represented by Equation (5), below.

pₜ=mₜ+nₜ+R (5)

The distance d_{t+dt} is the length of vector extending from O_{t+dt} to E. Equation (1) may be used to determine the lateral offset dₜ at time t at distance R from origin Oₜ, where dt is represented by Equation (6), below.

dₜ=Aₜ*R³+Bₜ*R²+Cₜ+R+Dₜ (6)

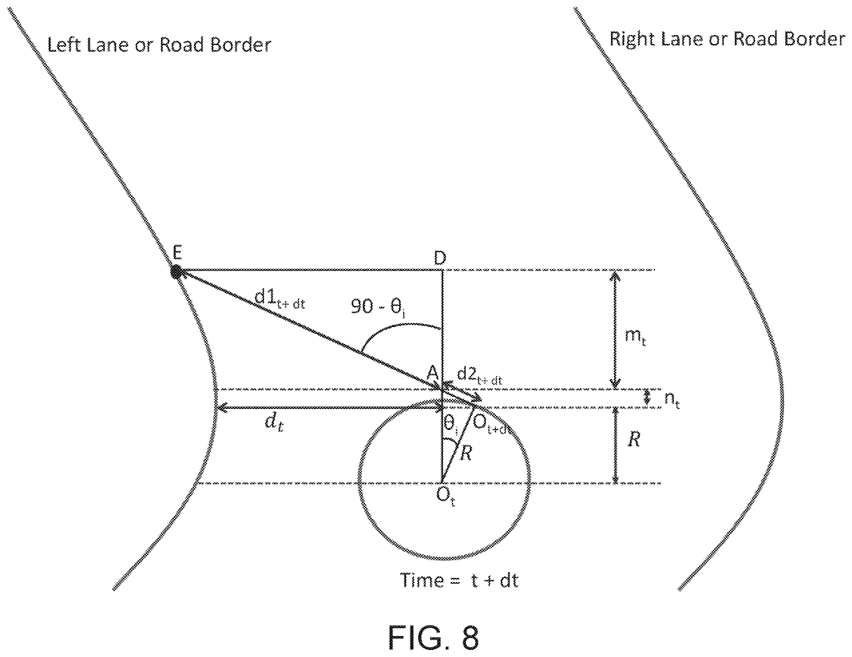

As shown in FIG. 8, distance d_{t+dt} is the sum of d1_{t+dt} and d2_{t+dt}, where d_{t+dt} is represented by Equation (7), below.

d_{t+dt}=d1_{t+dt}+d2_{t+dt} (7)

If the angle θᵢ is small, then d1_{t+dt} is approximately equal to dₜ, as represented by Equation (8), below.

d2_{t+dt}=d_{t+dt}−dₜ (8)

Using trigonometric properties, θᵢ is represented by Equation (9) and nₜ is represented by Equation (10), below. That is, using trigonometric properties in ΔAOₜ O_{t+dt} results in Equations (9) and (10).

$$tan ( {θ}_{i} ) = \frac{d {2}_{t + d t}}{R} \qquad ( 9 )$$

$${n}_{t} = R * ( \frac{1}{cos ( {θ}_{i} )} - 1 ) \qquad ( 10 )$$

Substituting cos (θᵢ) in Equation (10) for tan (θᵢ) may be used to calculate nₜ, represented by Equation (11), below.

nₜ=R*0.5*tan²(θᵢ) (11)

Using trigonometric properties, mt is represented by Equation (12), below. That is, using trigonometric properties in ΔADE results in Equation (12).

mₜ=dₜ*sin(θᵢ) (12)

Together, Equations (5), (11), and (12) may be used to calculate pₜ, represented by Equation (13), below.

pₜ=dₜ*sin(θᵢ)+R*0.5*tan²(θᵢ)+R θᵢ is an approximation, pₜ may be used to better approximate 0, as represented by Equation (14), below.

$${α}_{t} = 3 * {A}_{t} * {p}_{t}^{2} + 2 * {B}_{t} * {p}_{t} + {C}_{t} \qquad ( 14 )$$

Similarly, small angle approximation and Equation (2) at x=0 and time t+dt may be used to arrive at Equation (15), below.

α_{t+dt}=C_{t+dt} (15)

Together, Equations (4), (14), and (15) may be used to calculate angle θ, represented by Equation (16), below.

$$θ = 3 * {A}_{t} * {p}_{t}^{2} + 2 * {B}_{t} * {p}_{t} + {C}_{t} - {C}_{t + d t} \qquad ( 16 )$$

Angle θ may be used to determine the curvature of the path of travel or trajectory of the vehicle, κₜ₊₁, represented by Equation (17), below.

$${κ}_{t + d t} = \frac{θ}{R} \qquad ( 17 )$$

The pose of the vehicle at time t+dt, where the pose of the vehicle at time t is (Tₓ, T_{y}, θₜ), may be determined using Equations (18), (19), and (20), below.

T_{x,t+dt}=T_{x,t}+v*cos(θ) (18)

T_{y,t+dt}=T_{y,t}+v*cos(θ) (19)

O_{t+dt}=θₜ+θ (20)

The yaw rate of the vehicle at time t+dt is represented by Equation (21), below.

$${θ}_{t + dt}^{\cdot } = \frac{θ}{d t} \qquad ( 21 )$$

Thus, a vehicular driving assist system 12 determines an estimated heading of the equipped vehicle 10. The estimated heading may be used to determine a pose of the vehicle 10 in the x direction and the y direction, the curvature of the road or path or trajectory ahead of the vehicle 10, and the yaw rate of the vehicle 10 based on lane information, including lane marker and road edge data, from the forward-viewing camera 14 and/or road border data from the radar sensor 16. Determining the pose of the vehicle 10 in the x direction and the y direction enables the vehicular driving assist system 12 to generate a continuous coordinate mapping of the vehicle 10 relative to the road boundary. The vehicular driving assist system 12 may ensure that estimated vehicle states (e.g., a vehicle pose comprising a longitudinal position Tₓ, a lateral position T_{y}, and a heading angle θ of the vehicle 10), the road or trajectory curvature, and the lane information are in sync by estimating each based on data from the same sensor, such as when the vehicle 10 is capturing data from only the forward-viewing camera 14. Synchronizing the data from the same sensor mitigates spatial misalignment and reduces data processing latency. In some examples, the vehicular driving assist system 12 may estimate vehicle state information using data captured by a single sensor (e.g., the radar sensor 16 or the forward-viewing camera 14) by estimating the vehicle pose and calculating road or trajectory curvature and vehicle yaw rate based on the vehicle pose. That is, the vehicular driving assist system 12 may operate using a single sensor by estimating the vehicle pose and calculating the road or trajectory curvature and the vehicle yaw rate directly from camera or radar data.

Operating using a single sensor provides system robustness in environmental conditions degrading an alternate sensor modality, such as weather conditions affecting image capture by the forward-viewing camera 14 while the radar sensor 16 continues to capture the road border data. Thus, the vehicular driving assist system 12 may reduce or eliminate a requirement for additional sensors to measure and obtain vehicle states. Optionally, the vehicle state estimation algorithm may improve vehicle state estimation performance by acting as an additional measurement for the vehicular driving assist system 12 in examples where the vehicle 10 includes a separate vehicle state estimation module determining vehicle pose, road or trajectory curvature, and vehicle yaw rate (e.g., via sensor fusion). Acting as an additional measurement provides mathematical redundancy and allows the vehicular driving assist system 12 to cross-validate calculations against other onboard modules. A lane processing module ensures that the vehicular driving assist system 12 makes a valid determination of lane markers and/or road edges by determining scenarios such as lane widening or narrowing and lane merging or forking. In some exemplary implementations, responsive to determining scenarios such as the lane widening, the lane narrowing, the lane merging, or the lane forking, the lane processing module pauses pose updates or adjusts a confidence threshold associated with the lane markers to prevent errant trajectory calculations.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077;

US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front or forward-sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the disclosure, which is intended to be limited only by the scope of the appended claims, as interpreted according to the principles of patent law including the doctrine of equivalents.

1. A vehicular driving assist system comprising:
a sensor disposed at a vehicle equipped with the vehicular driving assist system and sensing exterior and at least forward of the vehicle, wherein the sensor is operable to capture sensor data;
at least one data processor operable to process sensor data captured by the sensor;
wherein the at least one data processor, responsive to processing of sensor data captured by the sensor at a first time interval, determines a first position of a road boundary of a road along which the vehicle is traveling;
wherein the at least one data processor determines, based at least in part on the determined first position of the road boundary, a first pose of the vehicle relative to the road boundary at the first time interval;
wherein the at least one data processor, responsive to processing of sensor data captured by the sensor at a second time interval, determines a second position of the road boundary at the second time interval;
wherein the at least one data processor determines, based at least in part on the determined second position of the road boundary at the second time interval, a second pose of the vehicle relative to the road boundary at the second time interval; and
wherein the at least one data processor, based at least in part on the determined first pose and the determined second pose, determines (i) a curvature of a path of travel of the vehicle and (ii) a yaw rate of the vehicle.

2. The vehicular driving assist system of claim 1, wherein the road boundary comprises at least one selected from the group consisting of (i) a lane marker, (ii) an edge of the road and (iii) a border of the road.

3. The vehicular driving assist system of claim 1, wherein the first pose and the second pose each include a position of the vehicle relative to the road boundary and an angle of the vehicle relative to the road boundary.

4. The vehicular driving assist system of claim 1, wherein the sensor comprises a front camera module (FCM) having a forward-viewing camera disposed at an in-cabin side of a windshield of the vehicle.

5. The vehicular driving assist system of claim 1, wherein the sensor includes a radar sensor.

6. The vehicular driving assist system of claim 1, wherein the vehicular driving assist system comprises a plurality of sensors, and wherein the plurality of sensors comprises at least the sensor and a radar, and wherein the sensor comprises a front camera module (FCM).

7. The vehicular driving assist system of claim 1, wherein the first pose and the second pose are determined based at least in part on (i) a velocity of the vehicle at each of the first time interval and the second time interval and (ii) an acceleration of the vehicle at each of the first time interval and the second time interval.

8. The vehicular driving assist system of claim 1, wherein determining the first pose and the second pose comprises determining, based at least in part on the road boundary at each of the first time interval and at the second time interval, a heading curvature of the road along which the vehicle is traveling.

9. The vehicular driving assist system of claim 1, wherein the vehicular driving assist system, responsive to determining (i) the curvature of the path of travel of the vehicle and (ii) the yaw rate of the vehicle, controls movement of the vehicle.

10. The vehicular driving assist system of claim 1, wherein the at least one data processor determines the first pose based at least in part on a lateral offset of the vehicle at the first time interval, and wherein the lateral offset of the vehicle at the first time interval is determined based at least in part on a perpendicular distance between the vehicle and the determined first position of the road boundary at the first time interval, and wherein the at least one data processor determines the second pose based at least in part on a lateral offset of the vehicle at the second time interval, and wherein the lateral offset of the vehicle at the second time interval is determined based at least in part on a perpendicular distance between the vehicle and the determined second position of the road boundary at the second time interval.

11. The vehicular driving assist system of claim 1, wherein the at least one data processor determines the first position and the second position of the road boundary responsive to determining that (i) the road has a constant width, (ii) the at least one data processor detects presence of the road boundary with a confidence value greater than a threshold confidence value and (iii) a coefficient for the road boundary is below a threshold coefficient value.

12. The vehicular driving assist system of claim 1, wherein, responsive to determining the curvature of the path of travel of the vehicle and the yaw rate of the vehicle, the vehicular driving assist system outputs (i) the first pose, (ii) the second pose, (iii) the curvature of the path of travel of the vehicle and (iv) the yaw rate to at least one of the group consisting of (a) a lane-centering system of the vehicle, (b) a lane-change assist system of the vehicle, (c) a lane-keep assist system of the vehicle and (d) a hands-free driving system of the vehicle.

13. The vehicular driving assist system of claim 1, wherein the first pose comprises a first longitudinal position, a first lateral position, and a first heading angle of the vehicle at the first time interval, and wherein the at least one data processor is operable to synchronize the first pose, the curvature of the path of travel, and the yaw rate with the road boundary by determining the first pose, the curvature of the path of travel, the yaw rate, and the road boundary exclusively from the sensor data captured by the sensor.

14. A method comprising:
capturing, via a sensor disposed at a vehicle and sensing an exterior and at least forward of the vehicle, sensor data;
processing, by at least one processor, the sensor data captured by the sensor at a first time interval to determine a first position of a road boundary of a road along which the vehicle is traveling;
determining, by the at least one processor, based at least in part on the determined first position of the road boundary, a first pose of the vehicle relative to the road boundary at the first time interval;
processing, by the at least one processor, the sensor data captured by the sensor at a second time interval to determine a second position of the road boundary at the second time interval;
determining, by the at least one processor, based at least in part on the determined second position of the road boundary at the second time interval, a second pose of the vehicle relative to the road boundary at the second time interval; and
determining, by the at least one processor, based at least in part on the determined first pose and the determined second pose, (i) a curvature of a path of travel of the vehicle and (ii) a yaw rate of the vehicle.

15. The method of claim 14, wherein the road boundary comprises at least one selected from the group consisting of (i) a lane marker, (ii) an edge of the road and (iii) a border of the road.

16. The method of claim 14, wherein the first pose and the second pose each include a position of the vehicle relative to the road boundary and an angle of the vehicle relative to the road boundary.

17. The method of claim 14, wherein the sensor comprises a front camera module (FCM) having a forward-viewing camera disposed at an in-cabin side of a windshield of the vehicle.

18. The method of claim 14, wherein the sensor includes a radar sensor.

19. The method of claim 14, wherein the sensor data is captured by a plurality of sensors, and wherein the plurality of sensors comprises at least the sensor and a radar, and wherein the sensor comprises a front camera module (FCM).

20. The method of claim 14, wherein the first pose comprises a first longitudinal position, a first lateral position, and a first heading angle of the vehicle at the first time interval, and wherein the method further comprises synchronizing the first pose, the curvature of the path of travel, and the yaw rate with the road boundary by determining the first pose, the curvature of the path of travel, the yaw rate, and the road boundary exclusively from the sensor data captured by the sensor.
